(19) United States
(12) Patent Application Publication
(10) Pub. No.: US 2021/0061320 A1
(43) Pub. Date: Mar. 4, 2021

(54) ULTRA-LIGHT WEIGHT BRAKE STICK

(71) Applicant: ULTRALIGHT RAILWAY BRAKE STICKS LLC, Canton, OH (US)

(72) Inventors: James M. Parsons, East Canton, OH (US); Michael Domer, Burbank, OH (US)

(73) Assignee: UL TRALIGHT RAILWAY BRAKE STICKS LLC, Canton, OH (US)

(21) Appl. No.: 16/925,830

(22) Filed: Jul. 10, 2020

Related U.S. Application Data
(60) Provisional application No. 62/891,797, filed on Aug. 26, 2019.

(51) Int. Cl. B61H 13/02

(52) U.S. Cl. CPC B61H 13/02

(57) ABSTRACT

An ultra-light railway stick device and method of operation are described herein. The ultra-light railway stick weighs less than 5 pounds and is made of carbon fiber as well as ultra-high molecular weight polyethylene. The ultra-light railway stick has a head portion generally shaped like an axe as well as a body that is hexagonal and may be covered in reflective strips.

### CROSS REFERENCE TO RELATED APPLICATIONS

This application claims the benefit of U.S. Provisional Application Ser. No. 62/891,797 filed on Aug. 26, 2019; the disclosure of which is incorporated herein by reference.

### TECHNICAL FIELD

Generally this disclosure is related to an ultra-light brake stick for engaging brake wheels on locomotives. More particularly, the disclosure is related to an ultra-light weight brake stick with a head portion and a rigid body. Specifically, the disclosure is related to an ultra-light brake stick for engaging brake wheels on locomotives with a head portion, a rigid body, an engagable portion where the brake stick weighs less than 2 pounds.

### BACKGROUND

### Background Information

Brake wheels on a railcar of a locomotive are often mounted out of reach of an operator. Laws, rules and regulations require that a section of railcars must be safely secured and locked to prevent any premature movement of the cars. As such, the operator must often climb a harrowing ladder or steps or climbing to a platform in order to reach the brake wheels and engage or disengage the wheels. Further, this act of reaching the brake wheels often puts the operator between adjacent railcars. As a result, after climbing and setting or releasing the brake wheel, the operator must then descend the ladder and proceed to dismount from a train car. In addition, brake wheels may be located toward one side of the train car and require a worker to not only climb a ladder but also traverse across a platform in order to reach the brake wheel. Workers are not allowed to stand on the tracks to elevate themselves to reach a brake wheel, as this is a safety violation. When a train is ready to depart, all of the brakes have to be disengaged. Engaging and disengaging the brake wheels is a very time consuming, laborious, and can be dangerous task. This is especially true in wet or icy conditions.

Manipulating the brake wheels generally requires a brakeman to climb onto a car, turn the brake wheel multiple turns, maybe as many as twenty, and proceed to then descend from the car. It is not uncommon for a brakeman to have to set or release forty or fifty hand brakes at a time. Thus, a brakeman may find it necessary to make over one thousand turns of brake wheels for one parking of a locomotive. Further, many injuries to brakemen result from mounting and dismounting the cars such as broken ankle, ankle tendon sprains or tears, torn knee ligaments, torn meniscuses, dislocated hips, and many smaller bumps, scrapes and bruises.

A common long handled utility tool, commonly referred to as a brake stick, is used to lock and unlock, tighten and un-tighten, set and release, or secure and unsecure the railcar of a locomotive brake wheel. The brake stick operator is required to physically stand either on the railroad vehicle itself, stand between the connected cars, or stand nearby the car or locomotive on potentially unstable ground surface material, (snow, ice, mud, uneven terrain, wet loose track ballast, etc.), found in and around the railroad vehicle and tracks during any time of day or year in any adverse weather condition.

### SUMMARY

As such, there exists the need for a light weight and easy to use in order to engage and disengage brake wheels on locomotives.

In one aspect, an exemplary embodiment of the present disclosure may provide a brake stick device comprising a rigid tubular body with a first end and a second end; an engagable member located between the first end and second end; and a head portion fixedly attached to the first end of the body; wherein the head portion comprises a first side, a second side opposite the first side, a first end, a second end opposite the first side, a top side, a bottom side opposite the top side, a bulbous portion proximate the first side, a flat portion generally between the first side and second side, and a tapered portion proximate the second side, wherein the head portion is adapted to interface with a brake wheel on a locomotive. This embodiment or another embodiment may provide a pair of angled surfaces on the bottom side. This embodiment or another embodiment may provide a first horizontal wall surface that abuts the first end of the tubular body on the bottom side. This embodiment or another embodiment may provide a second horizontal surface located between the pair of angled surfaces on the bottom side. This embodiment or another embodiment may provide the top side further includes a projection. This embodiment or another embodiment may provide the rigid tubular body is hollow. This embodiment or another embodiment may provide the engagable member is a magnet. This embodiment or another embodiment may provide an end cap located at the second end of the rigid body of the brake stick. This embodiment or another embodiment may provide the end cap has a first cylindrical portion and a second cylindrical portion that is adapted to engage with a stick support. This embodiment or another embodiment may provide at least one reflective strip located between the first end and second end of the brake stick.

In another aspect, an exemplary embodiment of the present disclosure may provide a brake stick device comprising: a rigid body made of carbon fiber with a first end and a second end; an engagable member located between the first end and second end; a head portion fixedly attached to the first end of the body; wherein the head portion comprises a front side, a back side opposite the front side, a first side, a second side opposite the second side, a top side, a bottom side opposite the top side, a bulbous portion proximate the first side, a flat portion generally between the first side and second side, and a tapered portion proximate the second side, wherein the head portion is adapted to interface with a brake wheel on a locomotive; and an end cap fixedly connected to the second end; and wherein the brake stick device weighs less than 5 pounds. This embodiment or another embodiment may provide a pair of angled surfaces on the bottom side; a first horizontal wall surface that abuts the first end of the tubular body on the bottom side; and a second horizontal surface located between the pair of angled surfaces on the bottom side. This embodiment or another embodiment may provide the head portion is made of ultra-high molecular weight polyethylene and the rigid tubular body is made of carbon fiber.

In yet another aspect, an exemplary embodiment of the present disclosure may provide a method comprising: obtaining a tool, wherein the tool has a rigid body with a first end and a second end; a head portion fixedly attached to the first end of the body; wherein the head portion comprises a front side, a back side opposite the front side, a first side, a second side opposite the second side, a top side, a bottom side opposite the top side, a bulbous portion proximate the first side, a flat portion generally between the first side and second side, and a tapered portion proximate the second side, wherein the head portion is adapted to interface with a brake wheel on a locomotive; wherein the tool weighs less than 2 pounds; extending the tool to engage the brake wheel of a locomotive; rotating the brake wheel of a locomotive in a first direction with the tool, thereby locking the locomotive in place; and disengaging the tool from the brake wheel. This embodiment or another embodiment may provide attaching the tool to a portion of the locomotive for storage. This embodiment or another embodiment may provide reengaging the brake wheel with the tool; rotating the brake wheel of the locomotive in a second direction with the tool, thereby permitting the locomotive to move; and disengaging the tool from the brake wheel. This embodiment or another embodiment may provide attaching the tool to a portion of the locomotive for storage. This embodiment or another embodiment may provide prior to extending the tool: engaging a first coupler of a locomotive in engagement and a second coupler on a second locomotive with the tool; and rotating the tool to disengage the first coupler from the second coupler. This embodiment or another embodiment may provide contacting the brake wheel with a top side or a bottom side of the head portion of the tool. This embodiment or another embodiment may provide wherein the head portion is made of UHMW polyethylene.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a front elevation view of an exemplary ultra-light brake stick.

FIG. 2 (FIG. 2) is a front right view of a first end of the exemplary ultra-light brake stick.

FIG. 3 (FIG. 3) is a front right exploded view of the first end of the exemplary ultra-light brake stick.

FIG. 4 (FIG. 4) is a front elevation view of a head isolated from the rest of the exemplary ultra-light brake stick.

FIG. 5 (FIG. 5) is a top plan view of the head taken along line 5-5 in FIG. 4.

FIG. 6 (FIG. 6) is a bottom plan view of the head taken along line 6-6 in FIG. 4.

FIG. 7 (FIG. 7) is a front right perspective view of a second end of the exemplary ultra-light brake stick.

FIG. 8 (FIG. 8) is a front right exploded view of the second end of the exemplary ultra-light brake stick.

FIG. 9 (FIG. 9) is a cross sectional view of the first end taken along line 9-9 in FIG. 3.

FIG. 10 (FIG. 10) is an operational view of an operator using the exemplary ultra-light brake stick on a brake wheel of a locomotive car.

FIG. 11 (FIG. 11) is a further operational view of the exemplary ultra-light brake stick in a stored position.

Similar numbers refer to similar parts throughout the drawings.

### DETAILED DESCRIPTION

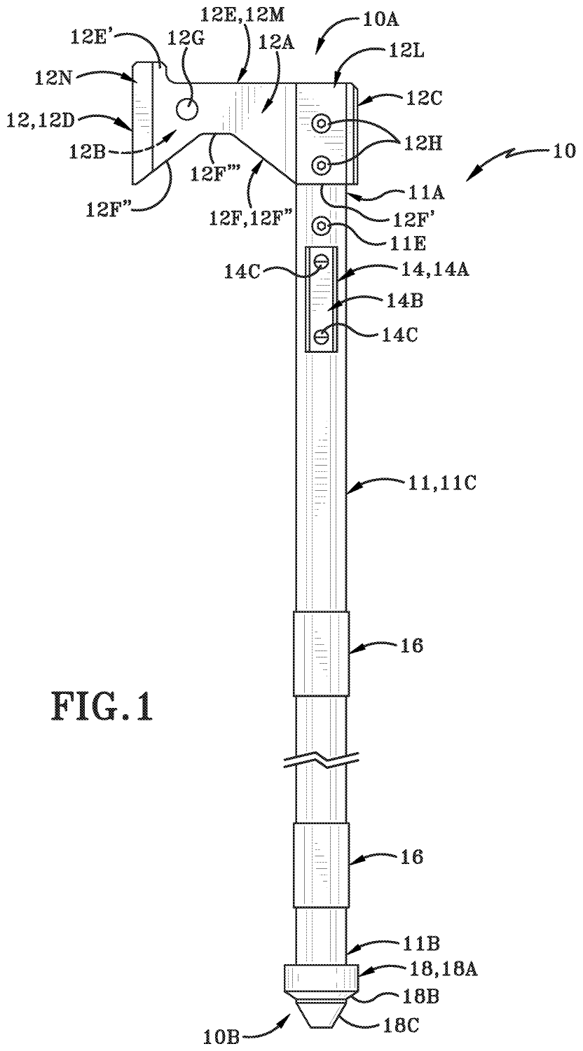

A new brake stick 10 and method of operation thereof is depicted in the present disclosure and throughout FIGS. 1-11. Brake stick 10 is a new and improved apparatus for rotating brake wheels on locomotives, as will be discussed hereafter. The brake stick 10 may also be referred to as an ultra-light brake stick 10 as the weight of the brake stick is less than 5 pounds. In a further embodiment, it may be less than 3 pounds. In yet another further embodiment it may be less than 2 pounds.

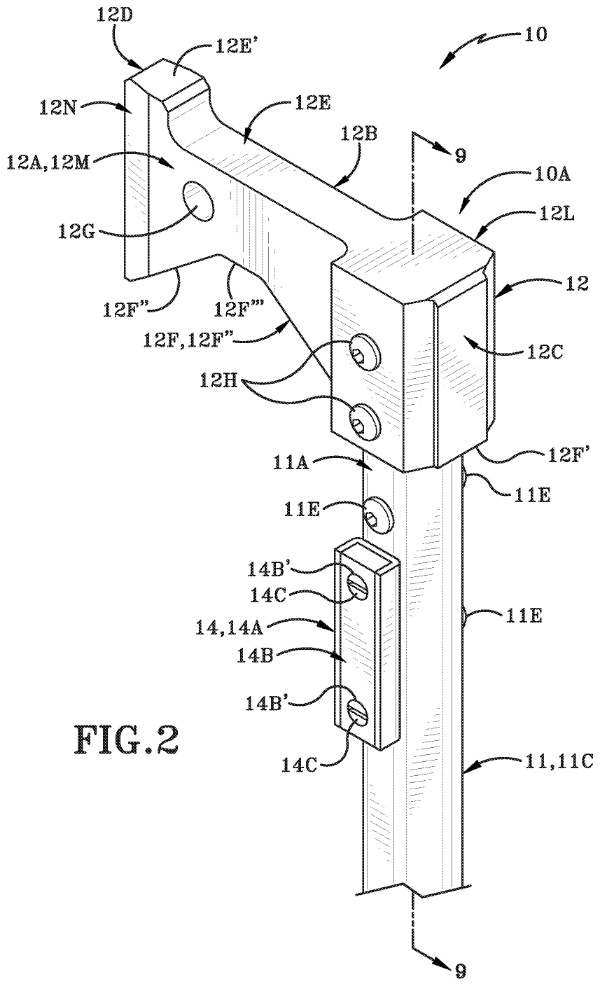

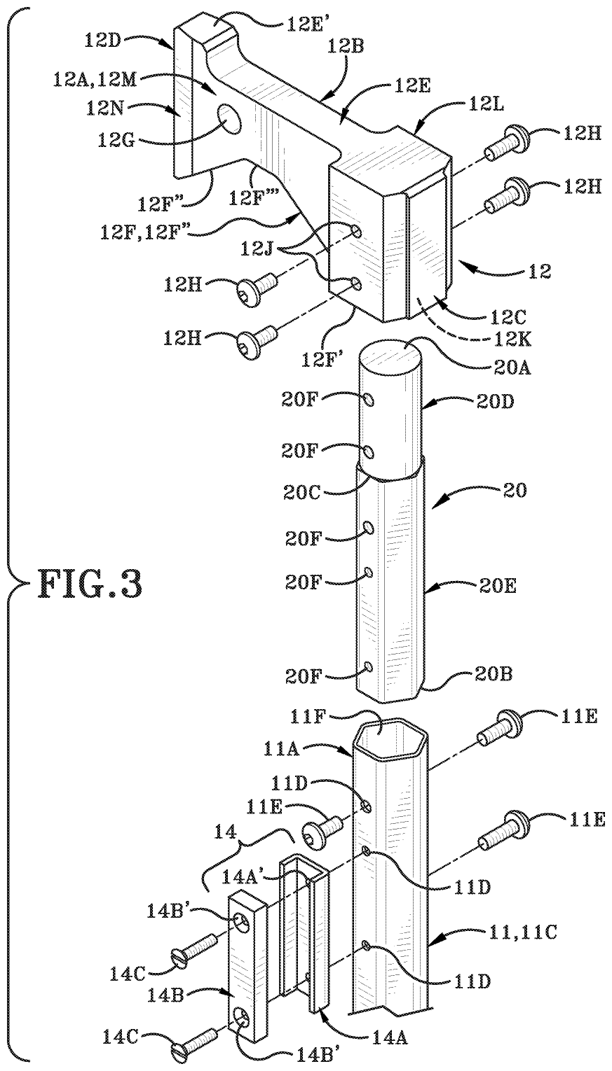

Referring now to FIG. 1, FIG. 2, and FIG. 3, a front elevation view of a brake stick 10 is shown. The brake stick 10 has a body which includes a first end 10A and a second end 10B located a distance away and is vertically opposed to the first end 10A. In some exemplary embodiments the body of the brake stick may be hexagonal, smooth, square shaped or otherwise polygonal. The brake stick 10 has a generally tubular body 11. The generally tubular body 11 has a first end 11A, and a second end 11B that is vertically opposed to the first end 11A. The tubular body further has a sidewall 11C that in one embodiment is generally hexagonal in shape. Further, there are a plurality of apertures 11D with a plurality of fasteners 11E operatively placed therein. The tubular body 11 has a hollow interior 11F, as will be discussed later.

Proximate the first end 10A, there is a head portion 12. The head portion 12 has a body that is generally axe shaped and is broken into different sections of varying thickness and dimension as will be discussed later with respect to later figures. The head portion has a first side 12A, a second side 12B that is transversely opposed to the from 12A, a first end 12C, a second end 12D that is longitudinally opposed to the first end 12C, a top side 12E, and a bottom side 12F that is vertically opposed to the top side 12E. The top side 12E further has a projection portion 12E′ as will be discussed later. The bottom side 12F has a first horizontal surface 12F′ that abuts end 11A, a pair of angled surfaces 12F″ and a second horizontal surface 12F′″ therebetween the angled surfaces 12F″. The pair of angled surfaces 12F″ are bound by the first horizontal wall 12F′ while the other is bound by the second end 12D. Further included in the head portion 12 is an aperture 12G laterally above the angled surface 12F″ proximate the second end 12D.

Further included are a plurality of fasteners 12H that fit into a plurality of apertures 12J to attach the head portion 12 at the first side 12A and second side 12B. The head further includes a recess 12K that extends between the first side 12A and the second side 12B operative to accept the first end 11A of the tubular body 11.

Further vertically down from the head portion 12 on the brake stick 10 is an engagable member 14. The engagable member 14 is attached to the brake stick 10 via a bracket 14A and a series of fasteners 14C that engage at least one aperture 14A′ in the bracket 14A and at least one apertures 14B′ within the engagable portion 14B to at least one tubular body aperture 11D. In one embodiment the engagable member 14 is a strong magnet capable of engaging a magnetic portion on a rail car as will be discussed later with respect to operation.

Even further vertically down from the head portion 12 and the engagable member 14 is a reflective strip 16. The reflective strip 16 is made of a reflective material or tape so that it may be easily seen from a distance away to further protect an operator. Each reflective strip 16 in one embodiment is comprised of a flexible and elastic synthetic resin base. The synthetic resin base can be made from a variety of resin materials well known in the art including acrylic acid esters such as polymethyl, methocrylate, and polybulyl, acrylate and others. The reflective strip 16 has an outer reflective surface and in one embodiment is comprised of reflective materials well known in the art and with a self-adhesive backing. The adhesive backing in one embodiment is one of the well-known pressure sensitive adhesives compatible with the material of the brake stick 10 and the synthetic resin base material and an example of such a material is a butyl-type adhesive which is covered with a removable release paper. The elastic flexible nature of the reflective strip 16 allow the same to conform to the body of the brake stick 10 thereby shaping the reflective strip 16 into a conformational shape to the body. Such a shape enhances and concentrates the reflection of the light from an oncoming vehicle or other such light source so as to improve the visibility of the brake stick 10. The bands of the reflective strips 16 on the brake stick 10 will clearly indicate or mark the tool in both daylight and at night by reflecting the lights in a concentrated manner. In some embodiments the reflective strip may cover a majority of the outside of the brake stick 10. In this embodiment shown, there are two strips one proximate the engagable member 14 and another proximate the second end 10B.

Further, at the second end 10B of the brake stick 10 there is an end cap 18. The end cap has a body that has a first cylindrical portion 18A, a chamfered edge 18B below the first cylindrical portion 18A and the chamfered edge 18B tapers an abbreviated frustroconical piece 18C.

In one embodiment, the brake stick 10 is made of ultra-light weight carbon fiber while the head portion and end cap are made of ultra-high molecular weight polyethylene. Other embodiments may be of different materials, but the goal is for the entirety of the brake stick to be less than 5 pounds. In further embodiments it may be less than 2 pounds. The ultra-high molecular weight polyethylene has extremely low moisture absorption, a very low coefficient of friction, and is self-lubricating and is highly resistant to abrasion. Compared to carbon steel it may be ten times more resistant to abrasion. As such, the brake stick 10 components that make the most contact during operation and are subject to the greatest forces are incredibly abrasion resistant. The coefficient of friction of the ultra-high molecular weight polyethylene is significantly lower than nylon and acetal type materials, and is comparable to polytetrafluoroethylene (PTFE). However, when compared to PTFE the ultra-high molecular weight polyethylene has superior abrasion resistance. Further, the ultra-high molecular weight polyethylene is odorless and nontoxic even if it were to shear.

Referring specifically to FIG. 3, a head extension piece 20 is shown. The head extension piece 20 has a body with a first end 20A and a second end 20B vertically opposed to the first end 20A. The head extension piece 20 further may comprise a transition point 20C, where the shape of the head extension piece 20 may change from a first shape 20D to a second shape 20E along with apertures 20F. The first shape 20D is of a complementary shape to that of a recess 12K on the head portion 12. In an exemplary embodiment the recess spans from the bottom side 12F nearly through to the top side 12E of the head portion 12.

As such, the first shape 20D will nest within the recess 12K of the head portion 12 and be operative to accept fasteners 12H through the first side 12A into the fastener apertures 12J until making contact with the head extension piece apertures 20F and being engaged thereto. Further the second end 20B of the head extension piece is placed into the first end 10A of the brake stick 10. Similar to the first shape 20D, the second shape 20E is complementary to the shape of the body of the brake stick 10. In some exemplary embodiments the first shape 20D of the head extension piece 20 may be hexagonal, circular, smooth, square shaped or otherwise polygonal. In some exemplary embodiments the second shape 20E of the head extension piece 20 may be hexagonal, circular, smooth, square shaped or otherwise polygonal. The second end 20B is then secured to the brake stick 10 with a fastener 11E that goes through the aperture 11D of the brake stick 10 to make contact with the aperture 20F of the head extension piece 20. As a result, the head portion is fixedly attached and si rigid with respect to the body of the brake stick 10. Similarly, the engagable member 14 is attached by use of a fastener 14C through the apertures 14A′ and 14B′ that then engage the second end 20B of the head extension piece 20 at its aperture 20F.

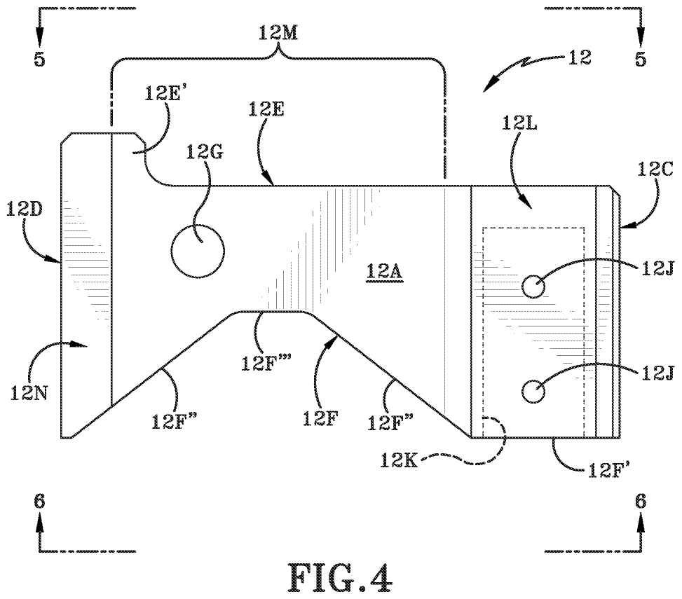

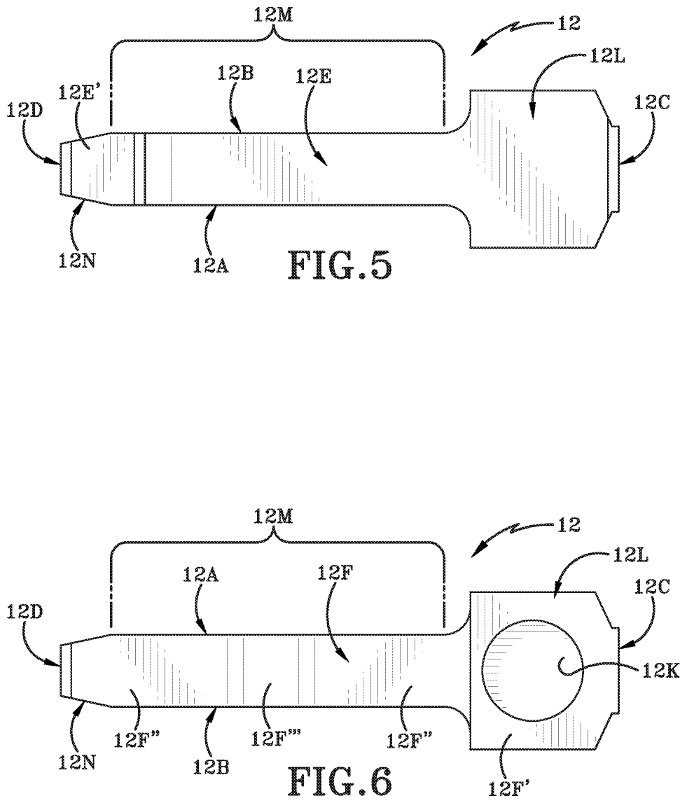

Referring specifically to FIG. 4, FIG. 5 and FIG. 6, views of the isolated head portion 12 are shown. Referring specifically to FIG. 5 the overall shape of the head portion 12 may be appreciated. Proximate the first end 12C, and on the top side 12E there is a bulbous portion 12L of the head portion 12 that transitions into a generally flat portion 12M followed by a tapered portion 12N that is generally frustroconical in shape.

Referring specifically to FIG. 4, the top surface 12E is shown as generally flat until it slopes upwardly to the projection 12E. Similarly, in this view, the bottom side 12F may be seen to have four distinct surfaces, the first horizontal wall 12F′ that abuts the end 11A followed by a tapering to the angled surface 12F″ and then the tapering to the second horizontal surface 12F′″ that runs substantially parallel to the first horizontal surface 12F′, followed by tapering into another angled surface 12F″. The angle between the angled surfaces in one embodiment has an angle of about 90 to about 150 degrees. In a further embodiment, is may be about 100 to about 140 degrees. In yet another embodiment it may be about 105 degrees to about 120 degrees.

Referring to FIG. 5 specifically, a top view of the head 12 is shown. In this view, one may see the bulbous portion 12L that starts at the first end 12C with an angled piece before being relatively square in nature prior to arcing to the flat portion 12M. The flat portion 12M is so named as from this view, the first side 12A and second side 12B run parallel to one another and provide an identical thickness in this portion that is less than that of the bulbous portion 12L but is more or equal to than the largest portion of the tapered portion 12N. The flat portion 12M further includes the projection 12E′ that arcs upwardly 90 degrees until the tapered portion 12N starts. The tapered portion 12N starts at a thickness equal to the flat portion 12M before tapering to less than or equal to that at the second end 12D. In one embodiment the taper is at an angle of about 5 to about 40 degrees. In another embodiment the taper is at an angle of about 10 to about 30 degrees. In a further embodiment the angle may be about 20 degrees.

Referring specifically to FIG. 6, the bottom view of the head 12 is shown. In this view, similar to FIG. 5, one may see the boubous portion 12L at the bottom side 12F that starts at the first end 12C with an angled piece before being relatively square in nature prior to arcing to the flat portion 12M. Within the bulbous portion 12L, the recess 12K is shown. In one embodiment the recess 12K is circular in order to accommodate the first end 20A of the head extension piece 20, but the recess 12K may be any complementary shape to the first end 20A of the head extension piece 20. The flat portion is so named as from this view and the view in FIG. 5, the first side 12A and second side 12B run parallel to one another. and provide an identical thickness in this portion that is less than that of the bulbous portion 12L but is more or equal than the largest portion of the tapered portion 12N. In the bottom side 12F the flat portion encompasses the angled surfaces 12F″ and the second horizontal surface 12F′″ located between the angled surfaces 12F″. The tapered portion 12N starts at a thickness less than or equal to the flat portion 12M before tapering to less than that at the second end 12D. The taper is constant between the top side 12E and bottom side 12F. In one embodiment the taper is at an angle of about 5 to about 40 degrees. In another embodiment the taper is at an angle of about 10 to about 30 degrees. In a further embodiment the angle may be about 20 degrees.

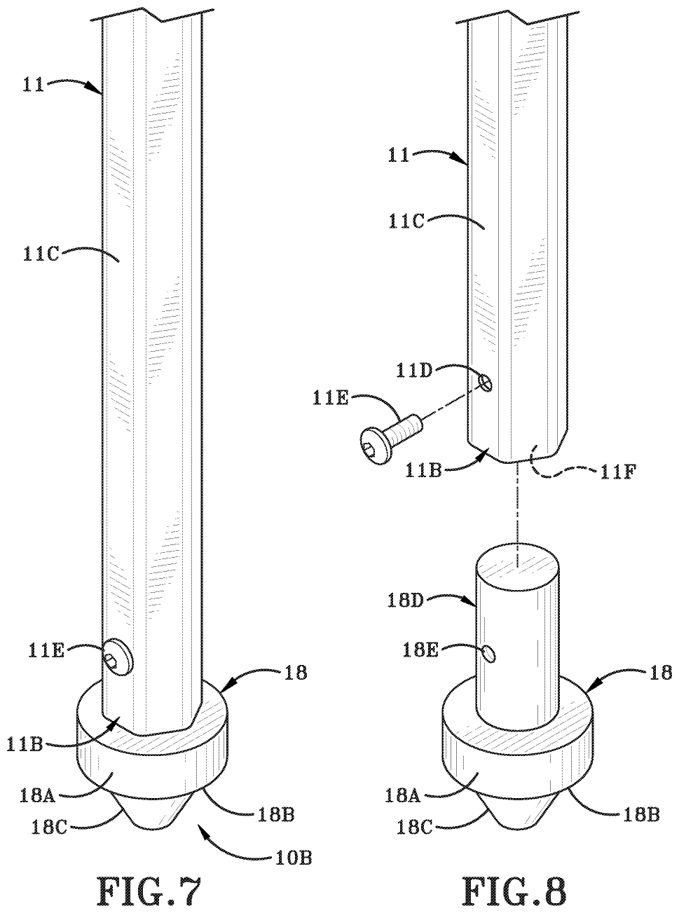

Referring now to FIG. 7 and FIG. 8, a front right perspective view of a second end of the exemplary brake stick 10 is shown. In this view we can see that the end cap 18 has a second cylindrical portion 18D as well as a threaded aperture 18E. The end cap 18 is attached proximate the second end 10B of the brake stick 10 through the use of a fastener 11E. The fastener 11E is placed through the aperture 11D and then abuts the aperture 18E on the second cylindrical portion 18D of the end cap 18. In one embodiment the cylindrical portion is cylindrical but in other embodiments it may be otherwise hexagonal, smooth, square shaped or otherwise polygonal.

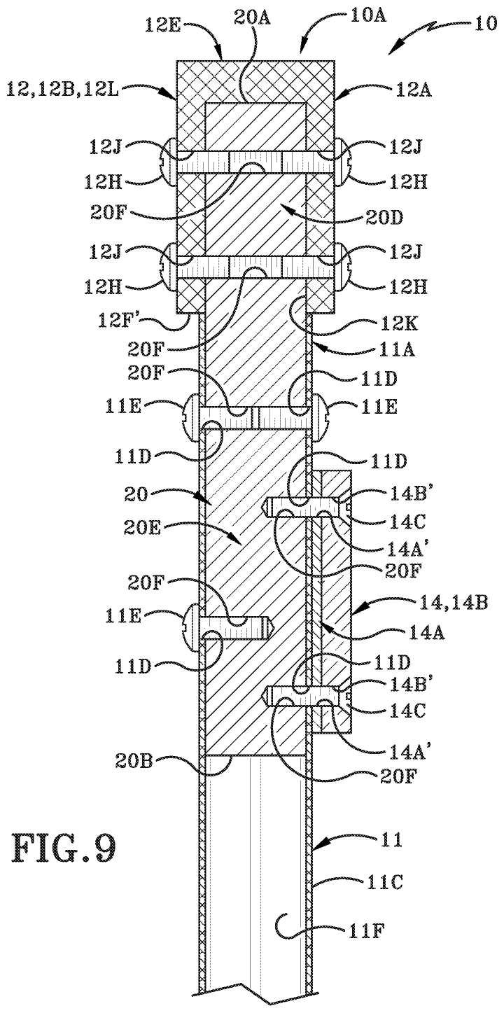

FIG. 9 shows a cross sectional view of the first end taken along line 9-9 in FIG. 3. In this view we may see the interplay between the plurality of apertures 11D and fasteners 11E that are attached proximate the first end 10A and the head portion 12 along with the head extension piece. Further, the attachment of the engagable member via the fasteners 14C placed through the apertures 14A′ and 14B′ are shown.

Having thus described an exemplary non-limiting configuration of the brake stick 10, its operation will be discussed with reference to some exemplary features used with the various embodiments.

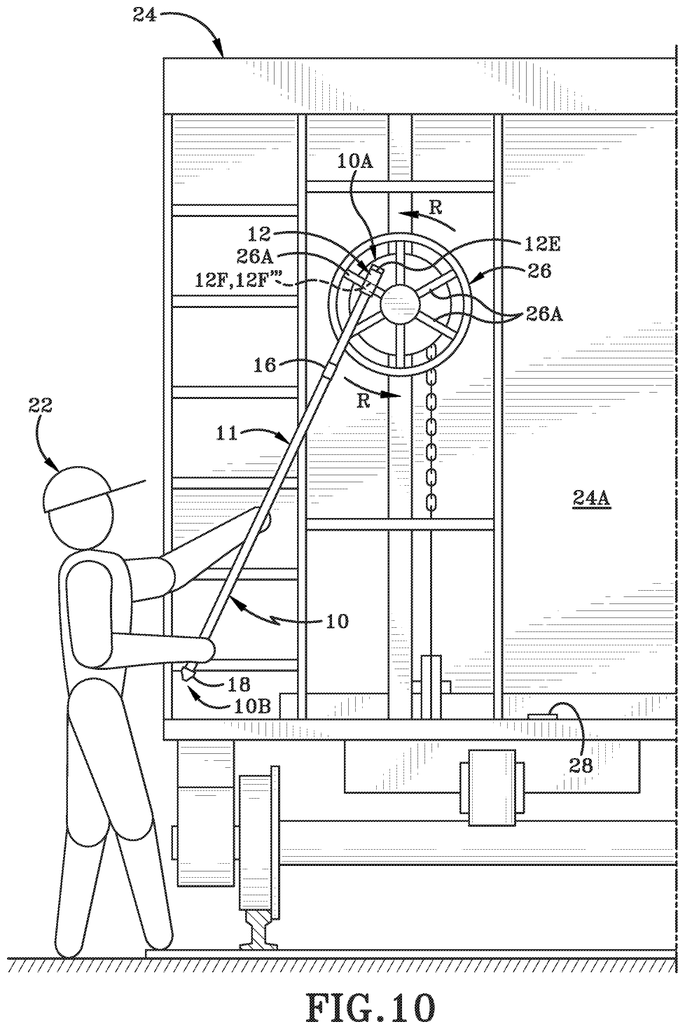

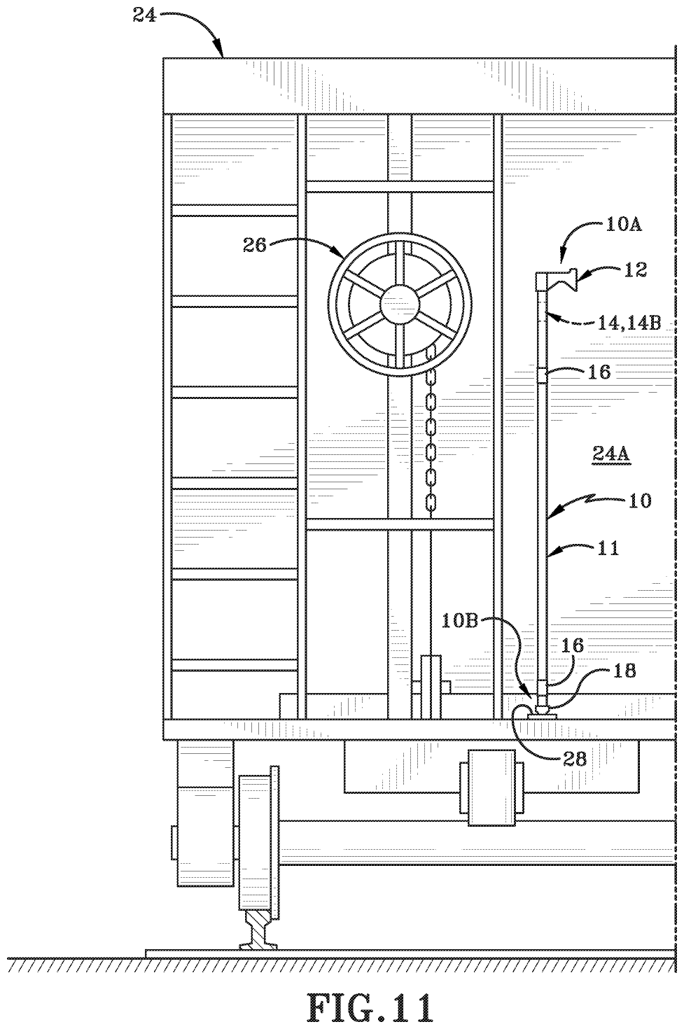

An operational view of an operator 22 using an exemplary brake stick 10 is shown in FIG. 10. The operator 22 may grab a hold of a locomotive car 24 brake wheel 26 with the brake stick 10. The operator may then rotate the brake wheel 26 in a first direction “R”. As used herein, the operator may also rotate the brake wheel 26 in a second direction. It will be understood that rotation in a first direction may be operative to lock the brakes of the locomotive car and in a second direction is operative to unlock the brakes.

As such, the operator 22 would place the brake stick on the rung 26A of a brake wheel 26 at the bottom side 12F of the head portion 12 and begin to rotate the brake wheel 26 in a first direction “R”. Ideally, for the best grip and interfacing between the brake stick 10 and the rung 26A of the brake wheel 26 the rung 26A would be placed on the second horizontal surface 12F′″ of the head 12 at the bottom side 12F and between the two angled surfaces 12F″ also on the bottom 12F. As such, the brake wheel 26 rung 26A would be secure to allow maximized force transfer between the operator 22 and brake stick 10 and rung 26A, allowing for efficient transfer. Then, as the brake wheel 26 begins to rotate the operator 22 may either reposition the brake stick 10 to reengage the second horizontal surface 12F′″ or may begin to use the brake stick at an angle and engage the angled surfaces 12F″. Additionally, the operator may rotate the brake stick 10 in order to use the top side 12E, at the flat portion 12M, with help from the projection 12E′ on the top side 12E to push the rung 26A in a manner to continue along in first direction “R”. Thereby repeating the rotation in a first direction “R” until significant resistance is felt locking the locomotive car into place.

The head portion 12 of the brake stick 10 is operative to remain in place and to not move around in any way as the head portion 12 is rigidly attached to the first end 10A of the brake stick 10 through the head portions' 12 attachment via the fasteners 12H. The head portion 12 is then removed or otherwise disengaged from contact with the rung 26A of the brake wheel 26. The brake stick 10 may then be attached to any metal portion of the locomotive by its engagable portion 14, via a high strength magnet.

Similarly, the operator 22 would place the brake stick on the rung 26A of a brake wheel 26 at the bottom side 12F of the head portion 12 and begin to rotate the brake wheel 26 in a second direction. Similar to that of rotation in the first direction, for the best grip and interfacing between the brake stick 10 and the rung 26A of the brake wheel 26 the rung 26A would be placed on the second horizontal surface 12F′″ of the head 12 at the bottom side 12F and between the two angled surfaces 12F″ also on the bottom 12F. As such, the brake wheel 26 rung 26A would be secure to allow maximized force transfer between the operator 22 and brake stick 10 and rung 26A, allowing for efficient transfer. Then, as the brake wheel 26 begins to rotate the operator 22 may either reposition the brake stick 10 to reengage the second horizontal surface 12F′″ or may begin to use the brake stick at an angle and engage the angled surfaces 12F″. Additionally, the operator may rotate the brake stick 10 in order to use the top side 12E, at the flat portion 12M, with help from the projection 12E′ on the top side 12E to push the rung 26A in a manner to continue along in a second direction. Thereby repeating the rotation in a second direction until significant resistance is felt thereby fully unlocking the locomotive car allowing it free to move.

Similar to the first direction “R”, the head portion 12 is operative to remain in place during rotation of the brake wheel in a second direction and would not move around in any way as the head portion 12 is rigidly attached to the first end 10A of the brake stick 10 through the head portions' 12 attachment via the fasteners 12H. The head portion 12 is then removed or otherwise disengaged from contact with the rung 26A. The brake stick 10 may then be attached to any metal portion of the locomotive by its engagable portion 14, via a high strength magnet.

Though not shown, the brake stick 10 is further shaped that it may facilitate disengagement of the knuckle couplers on railroad cars. A railroad car can traditionally have a knuckle coupler that links the first railroad car to another, or a second, railroad car. Knuckle couplers generally have a J-shaped hook for linking another J-shaped hook of the second railroad car. The knuckle coupler pivotally engaged the railroad car for permitting the generally J-shaped hook to be displaced during engagement with the other generally J-shaped hook. Generally, an operator may need to apply manual force to the knuckle coupler in order to disengage the J-shaped hooks. This places the operator in a precarious situation where he risks bodily harm or death.

However, now the head 12 of the brake stick may be inserted into the knuckle coupler and may be rotated to break the connection between the two J-shaped hooks of the knuckle coupler, thereby avoiding the need to place the operator in a dangerous situation. Specifically, the head 12 is so shaped to include the projection 12E′ that may be placed within the J-shaped hook and when the head 12 is rotated this projection 12E′ may break the engagement of two J-shaped hooks. Additionally, the tapered portion 12N at the second end 12D may be operative to be placed into contact with the coupler in order to properly disengage with the other coupler, the tapered portion 12N may be inserted to the extent that it may fit, up until the flat portion 12M. When resistance is felt that the tapered portion 12N may be inserted no more, or otherwise visual indication, the head portion 12 is then rotated to facilitate the breaking of the connection between the J-shaped hooks. Once the connection between the locomotive cars is disengaged, the head portion 12 is then removed or otherwise disengaged from contact with the coupler The brake stick 10 may then be attached to any metal portion of the locomotive by its engagable portion 14, via a high strength magnet.

Referring specifically to FIG. 11, a further view of the locomotive car 24 is shown. In this view, the locomotive car 24 is shown with the brake stick 10 attached to the car 24 at a side wall 24A. This obviates the need for storage in a telescoping manner. Telescoping poles or brake sticks, such that are described in the prior art have the tendency to stick and not fully extend, or be unruly when fully extended providing the tool would collapse back onto itself. As such, the brake stick 10 of the current disclosure removes the need for a telescoping brake stick as it may be stored and moved freely, due to its extreme light weight and magnetic engagements and overall small foot print. Similarly, there may be a stick support 28C in which the conical portion 18C may engage with. The stick support 28C may be a grid or otherwise surface on the locomotive 24 that may accept the end cap 18 of the brake stick 10 and be adapted to hold the stick 10 with a friction connection therebetween.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A brake stick device comprising:
a rigid tubular body with a first end and a second end;
an engagable member located between the first end and second end; and
a head portion fixedly attached to the first end of the body; wherein the head portion comprises a first side, a second side opposite the first side, a first end, a second end opposite the first side, a top side, a bottom side opposite the top side, a bulbous portion proximate the first side, wherein the head portion is adapted to interface with a brake wheel on a locomotive.

2. The brake stick of claim 1, wherein the head portion further comprises:
a flat portion generally between the first side and second side.

3. The brake stick of claim 2, wherein the head portion further comprises:
a tapered portion proximate the second side.

4. The brake stick of claim 3, wherein the head portion further comprises:
a pair of angled surfaces on the bottom side.

5. The brake stick of claim 4, wherein the head portion further comprises:
a first horizontal wall surface that abuts the first end of the tubular body on the bottom side.

6. The brake stick of claim 5, wherein the head portion further comprises:
a second horizontal surface located between the pair of angled surfaces on the bottom side.

7. The brake stick of claim 1, wherein the top side further includes a projection.

8. The brake stick of claim 1, wherein the rigid tubular body is hollow.

9. The brake stick of claim 1, wherein the engagable member is a magnet.

10. The brake stick of claim 1, and further comprising:
an end cap located at the second end of the rigid body of the brake stick.

11. The brake stick of claim 9, wherein the end cap has a first cylindrical portion and a second cylindrical portion that is adapted to engage with a stick support.

12. The brake stick of claim 1, further comprising:
at least one reflective strip located between the first end and second end of the brake stick.

13. A method of turning a brake on a locomotive comprising:
extending a rigid body tool to engage the brake wheel of a locomotive with a head portion at least one of a top surface or a bottom surface of the tool;
rotating the brake wheel of a locomotive in a first direction with the tool, thereby locking the locomotive in place; and
disengaging the tool from the brake wheel.

14. The method of claim 13, further comprising:
attaching the tool to a portion of the locomotive for storage.

15. The method of claim 13, further comprising:
reengaging the brake wheel with the tool;
rotating the brake wheel of the locomotive in a second direction with the tool, thereby permitting the locomotive to move; and
disengaging the tool from the brake wheel.

16. The method of claim 15, further comprising:
attaching the tool to a portion of the locomotive for storage.

17. The method of claim 13, wherein prior to extending the tool:
engaging a first coupler of a locomotive in engagement and a second coupler on a second locomotive with the tool; and
rotating the tool to disengage the first coupler from the second coupler.

18. The method of claim 17, wherein engaging the first coupler further comprises:
contacting at least one of the top surface or the bottom surface with the first coupler.

19. The method of claim 13, wherein extending comprises:
contacting the brake wheel with at least one of a top side or a bottom side of the head portion of the tool.

20. The method of claim 19, wherein the head portion is made of UHMW polyethylene.
